(19) United States
(12) Patent Application Publication
(10) Pub. No.: US 2025/0300727 A1
(43) Pub. Date: Sep. 25, 2025

(54) MONITORING SYSTEM, MONITORING METHOD, AND NON-TRANSITORY COMPUTER-READABLE MEDIUM

(71) Applicant: NEC Corporation, Tokyo (JP)

(72) Inventor: Naofumi KUROSAWA, Tokyo (JP)

(73) Assignee: NEC Corporation, Tokyo (JP)

(21) Appl. No.: 18/986,874

(22) Filed: Dec. 19, 2024

(30) Foreign Application Priority Data
Mar. 19, 2024 (JP) 2024-043520

(51) Int. Cl. H04B 10/071; G01M 11/00; H04B 10/29

(52) U.S. Cl. CPC H04B 10/071; G01M 11/3109; H04B 10/29

(57) ABSTRACT

The monitoring system includes: a first acquisition unit configured to acquire light intensity of multiplexed light generated by multiplexing scattered light propagating through a first optical transmission line in a multi-core transmission line and crosstalk light propagating through a second optical transmission line by crosstalk between the first optical transmission line and the second optical transmission line; a second acquisition unit configured to acquire light intensity of the crosstalk light; and a calculation unit configured to calculate light intensity of the scattered light, based on the light intensity of the multiplexed light and the light intensity of the crosstalk light.

### INCORPORATION BY REFERENCE

This application is based upon and claims the benefit of priority from Japanese patent application No. 2024-043520, filed on Mar. 19, 2024, the disclosure of which is incorporated herein in its entirety by reference.

### TECHNICAL FIELD

The present disclosure relates to a monitoring system, a monitoring method, and a program.

### BACKGROUND ART

Japanese Unexamined Patent Application Publication No. 2007-060665 discloses a technique for monitoring an optical communication system by using an optical time domain reflectometer (OTDR).

### SUMMARY

When monitoring a multi-core transmission line, there is a possibility that checking of normality of a transmission line may be hindered by crosstalk.

The present disclosure has been made in order to solve such a problem, and an example object thereof is to provide a monitoring system, a monitoring method, and a program that improve accuracy of checking normality of a multi-core transmission line.

In a first example aspect according to the present disclosure, a monitoring system includes:
a first acquisition unit configured to acquire light intensity of multiplexed light generated by multiplexing scattered light propagating through a first optical transmission line in a multi-core transmission line and crosstalk light propagating through a second optical transmission line by crosstalk between the first optical transmission line and the second optical transmission line;
a second acquisition unit configured to acquire light intensity of the crosstalk light; and
a calculation unit configured to calculate light intensity of the scattered light, based on the light intensity of the multiplexed light and the light intensity of the crosstalk light.

In a second example aspect according to the present disclosure, a monitoring method includes:
acquiring light intensity of multiplexed light generated by multiplexing scattered light propagating through a first optical transmission line in a multi-core transmission line and crosstalk light propagating through a second optical transmission line by crosstalk between the first optical transmission line and the second optical transmission line;
acquiring light intensity of the crosstalk light; and
calculating light intensity of the scattered light, based on the light intensity of the multiplexed light and the light intensity of the crosstalk light.

In a third example aspect according to the present disclosure, a program causes a computer to execute:
processing of acquiring light intensity of multiplexed light generated by multiplexing scattered light propagating through a first optical transmission line in a multi-core transmission line and crosstalk light propagating through a second optical transmission line by crosstalk between the first optical transmission line and the second optical transmission line;
processing of acquiring light intensity of the crosstalk light; and
processing of calculating light intensity of the scattered light, based on the light intensity of the multiplexed light and the light intensity of the crosstalk light.

According to the present disclosure, it is possible to provide a monitoring system, a monitoring method, and a program that improve the accuracy of checking the normality of a multi-core transmission line.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram for describing cable tracing;

FIG. 2 is a diagram for describing a configuration of a related repeater;

FIG. 3 is a diagram for supplementarily describing crosstalk light;

FIG. 4 is a diagram for supplementarily describing crosstalk light;

FIG. 5 is a block diagram illustrating an example of a configuration of a monitoring system according to the present disclosure;

FIG. 6 is a flowchart illustrating an example of a flow of a monitoring method according to the present disclosure;

FIG. 7 is a diagram for describing an example of the configuration of the monitoring system according to the present disclosure;

FIG. 8 is a diagram for describing a modified example of a configuration of a repeater according to the present disclosure;

FIG. 9 is a diagram for describing an operation of the monitoring system according to the present disclosure;

FIG. 10 is a flowchart illustrating an example of the operation of the monitoring system according to the present disclosure;

FIG. 11 is a diagram for describing an example of the configuration of the repeater according to the present disclosure;

FIG. 12 is a diagram for describing a modified example of the configuration of the repeater according to the present disclosure;

FIG. 13 is a diagram for describing a modified example of the configuration of the repeater according to the present disclosure;

FIG. 14 is a diagram for describing a modified example of the configuration of the repeater according to the present disclosure;

FIG. 15 is a diagram for describing a modified example of the configuration of the repeater according to the present disclosure;

FIG. 16 is a diagram for describing a modified example of the configuration of the repeater according to the present disclosure;

FIG. 17 is a flowchart illustrating an example of the operation of the monitoring system according to the present disclosure;

FIG. 18 is a flowchart illustrating an example of the operation of the monitoring system according to the present disclosure;

FIG. 19 is a diagram for describing an example of the configuration of the repeater according to the present disclosure;

FIG. 20 is a diagram for describing a modified example of the configuration of the repeater according to the present disclosure;

FIG. 21 is a flowchart illustrating an example of the operation of the monitoring system according to the present disclosure; and

FIG. 22 is a block diagram illustrating an example of a hardware configuration of the monitoring system according to the present disclosure.

### EXAMPLE EMBODIMENT

### Study of First Example Embodiment

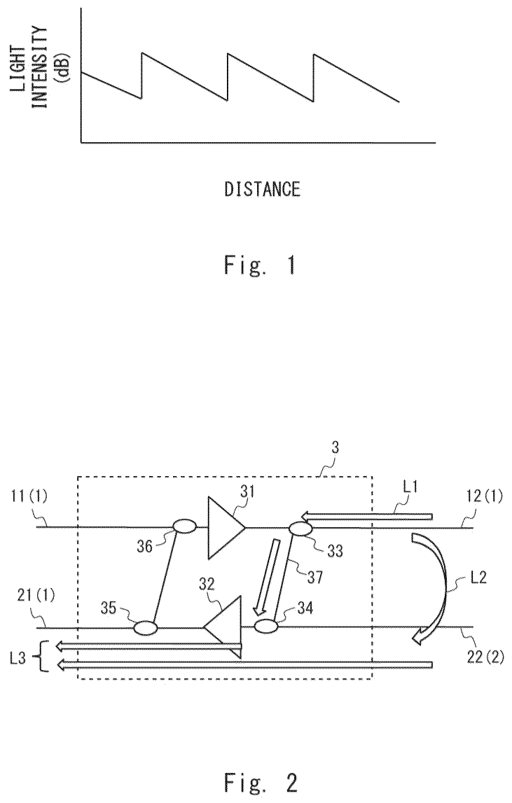

A problem of a related monitoring system is described with reference to FIGS. 1 to 4. The related monitoring system uses cable tracing with an OTDR or coherent optical time domain reflectometry (COTDR) to check the normality of a single core fiber (SCF) cable. FIG. 1 illustrates an example of cable tracing. The horizontal axis represents the distance from one end of the cable. The vertical axis represents the light intensity of scattered light (e.g., backscattered light).

In recent years, multi-core fibers (MCFs) have been applied to submarine transmission lines in order to increase the transmission capacity of the submarine transmission lines. When monitoring the MCF cables, crosstalk (XT) between cores may occur. When the monitoring system acquires a trace in which the XT component is added to the cable tracing illustrated in FIG. 1, there is a possibility that a trouble may occur in checking the normality of the cable.

FIG. 2 is a diagram for describing an example of a configuration of a repeater 3 included in the related monitoring system. The MCF cable includes a first optical transmission line 1 being an ascending optical transmission line and a second optical transmission line 2 being a descending optical transmission line. The first optical transmission line 1 being an ascending optical transmission line includes a cable 11 and a cable 12. The second optical transmission line 2 being a descending optical transmission line includes a cable 21 and a cable 22.

The related monitoring system injects an optical pulse into one end (e.g., the left end in FIG. 2) of the first optical transmission line 1, and guides scattered light L1 generated in the first optical transmission line 1 to the second optical transmission line 2 being a descending transmission line. Further, crosstalk light L2 is generated by crosstalk between the cable 12 and the cable 22, and the crosstalk light L2 propagates through the second optical transmission line 2.

The repeater 3 is disposed between the cable 11 and the cable 12, and is also disposed between the cable 21 and the cable 22. The repeater 3 includes amplifiers 31 to 32 and optical couplers 33 to 36. The amplifier 31 amplifies an optical pulse input from the cable 11. The optical coupler 33 outputs the amplified optical pulse to the cable 12, and also outputs scattered light (e.g., Rayleigh scattered light) generated in the first optical transmission line 1 to the optical coupler 34. The path between the optical coupler 33 and the optical coupler 34 is referred to as a loopback path 37. The loopback path 37 guides the scattered light L1 to the second optical transmission line 2. The optical coupler 34 multiplexes the scattered light L1 and the crosstalk light L2, and outputs multiplexed light L3 to the amplifier 32. The amplifier 32 outputs the amplified multiplexed light L3 to the optical coupler 35. The optical coupler 35 outputs the amplified multiplexed light L3 to the cable 21. The optical coupler 36 operates in a manner similar to that of the optical coupler 34 when monitoring the state of the second optical transmission line 2.

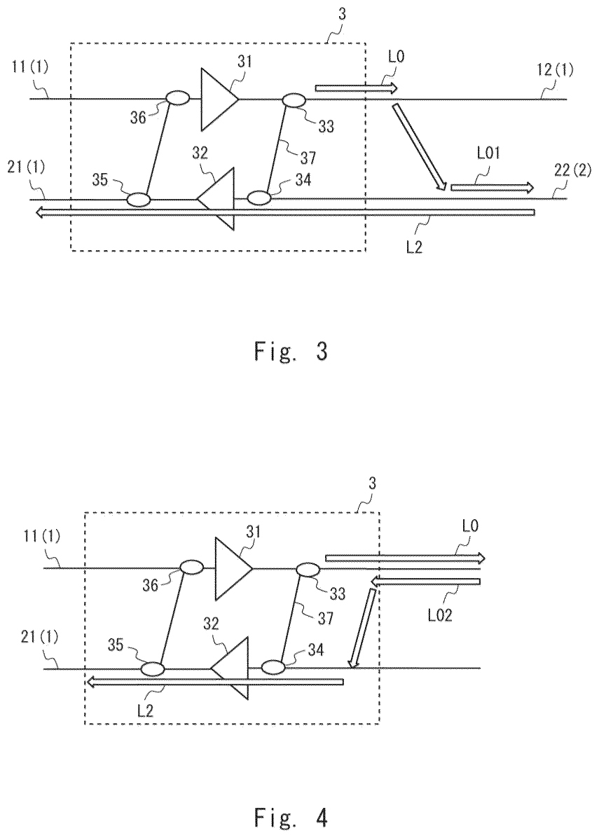

Next, with reference to FIGS. 3 and 4, a supplementary description is given of the crosstalk light L2 being input to the repeater 3. Referring to FIG. 3, crosstalk light L01 of pulsed light L0 propagates through the cable 22, and a portion of the crosstalk light L01 is scattered backward, thereby generating the crosstalk light L2. Referring to FIG. 4, a portion of the pulsed light L0 is scattered backward, thereby generating scattered light L02, and a portion of the scattered light L02 is crosstalked, thereby generating the crosstalk light L2. The actual crosstalk light L2 includes both a component generated by scattering of the crosstalk light L01 and a component generated by crosstalk of the scattered light L02.

The related monitoring system measures the light intensity of the multiplexed light L3 output from one end (e.g., the left end in FIG. 2) of the second optical transmission line 2 and thereby acquire trace data. Since the multiplexed light L3 includes the crosstalk light L2, there is a possibility that the accuracy of checking the normality of the cable may be lowered. The present inventors have conceived the present disclosure according to the example embodiments, based on the above-described examination.

### First Example Embodiment

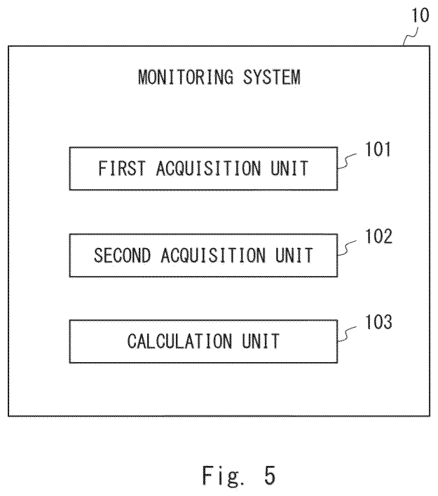

Hereinafter, a first example embodiment is described with reference to the drawings. FIG. 5 is a block diagram illustrating a configuration of a monitoring system 10 according to the present disclosure. The monitoring system 10 may be a computer apparatus that operates when a processor executes a program stored in a memory. The monitoring system 10 may be an information processing apparatus, for example, a server apparatus. Further, the monitoring system 10 may include a plurality of computer apparatuses. In such a case, constituent elements or functions of the monitoring system 10 may be distributed among the plurality of computer apparatuses. The plurality of computers may be connected with each other via a network or may be directly connected via a cable or the like.

The monitoring system 10 includes a first acquisition unit 101, a second acquisition unit 102, and a calculation unit 103. The first acquisition unit 101, the second acquisition unit 102, and the calculation unit 103 may be software or modules that execute processing when the processor executes a program stored in a memory. Alternatively, the first acquisition unit 101, the second acquisition unit 102, and the calculation unit 103 may be hardware such as a circuit or a chip.

The first acquisition unit 101 acquires the light intensity of multiplexed light generated by multiplexing scattered light and crosstalk light. The scattered light propagates through a first optical transmission line in a multi-core transmission line. The crosstalk light propagates through a second optical transmission line by crosstalk between the first optical transmission line and the second optical transmission line.

The second acquisition unit 102 acquires the light intensity of the crosstalk light.

The calculation unit 103 calculates the light intensity of the scattered light, based on the light intensity of the multiplexed light and the light intensity of the crosstalk light.

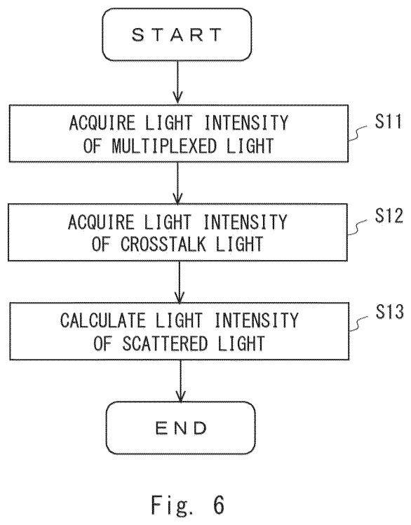

FIG. 6 is a flowchart illustrating an example of a flow of a monitoring method according to the present disclosure. First, the first acquisition unit 101 acquires the light intensity of the multiplexed light generated by multiplexing the scattered light and the crosstalk light (step S11). Next, the second acquisition unit 102 acquires the light intensity of the crosstalk light (step S12). The order of steps S11 and S12 may be reversed. Finally, the calculation unit 103 calculates the light intensity of the scattered light, based on the light intensity of the multiplexed light and the light intensity of the crosstalk light (step S13).

As described above, the monitoring system 10 acquires the light intensity of the crosstalk light, and calculates the light intensity of the scattered light, based on the light intensity of the multiplexed light and the light intensity of the crosstalk light. As a result, the monitoring system 10 is able to accurately monitor the light intensity of the scattered light.

### Second Example Embodiment

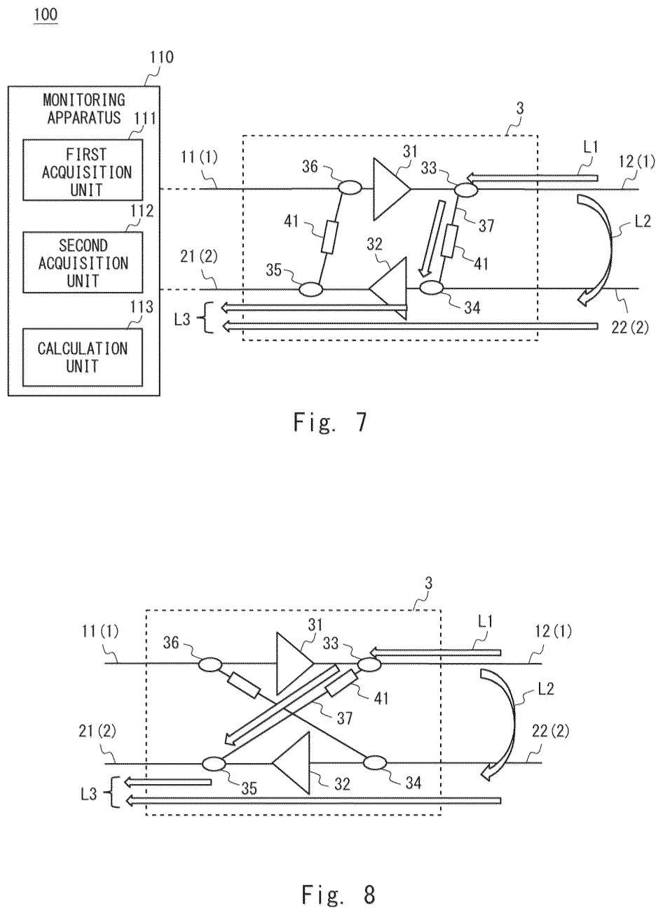

FIG. 7 is a diagram for describing an example of the configuration of a monitoring system 100 according to the present disclosure. The monitoring system 100 is a specific example of the monitoring system 10 described above. Comparing FIG. 2 with FIG. 7, a wavelength filter 41 is provided in a loopback path 37 of the monitoring system 100. The monitoring system 100 may include a plurality of repeaters 3.

The monitoring system 100 further includes a monitoring apparatus 110. It is also possible for the monitoring apparatus 110 to be interpreted as a specific example of the monitoring system 10 described above. The monitoring apparatus 110 includes a first acquisition unit 111, a second acquisition unit 112, and a calculation unit 113. The monitoring apparatus 110 may transmit an optical pulse from one end of a first optical transmission line 1 and measure the light intensity of multiplexed light L3 output from one end of a second optical transmission line 2. The monitoring apparatus 110 may be installed on land. The repeater 3 and the multi-core transmission line including the first optical transmission line 1 and the second optical transmission line 2 may be arranged at the seabed.

The first acquisition unit 111 is a specific example of the first acquisition unit 101 described above. The first acquisition unit 111 acquires trace data (referred to as first trace data) representing the intensity of the multiplexed light L3 per distance of the first optical transmission line 1, from the light intensity of a wavelength component of the multiplexed light L3 that is not cut by the wavelength filter 41.

The second acquisition unit 112 is a specific example of the second acquisition unit 102 described above. The second acquisition unit 112 acquires trace data (referred to as second trace data) representing the light intensity of crosstalk light L2 per distance of the first optical transmission line 1, from the light intensity of a wavelength component of the multiplexed light L3 cut by the wavelength filter 41.

The calculation unit 113 is a specific example of the calculation unit 103 described above. The calculation unit 113 generates trace data (referred to as third trace data) representing the light intensity of scattered light L1 per distance of the first optical transmission line 1, based on the difference between the first trace data and the second trace data.

FIG. 8 is a diagram for describing a modified example of the configuration of the repeater 3. Comparing the repeater 3 of FIG. 7 with the repeater 3 of FIG. 8, an optical coupler 33 of FIG. 8 outputs the scattered light L1 to an optical coupler 35 instead of an optical coupler 34.

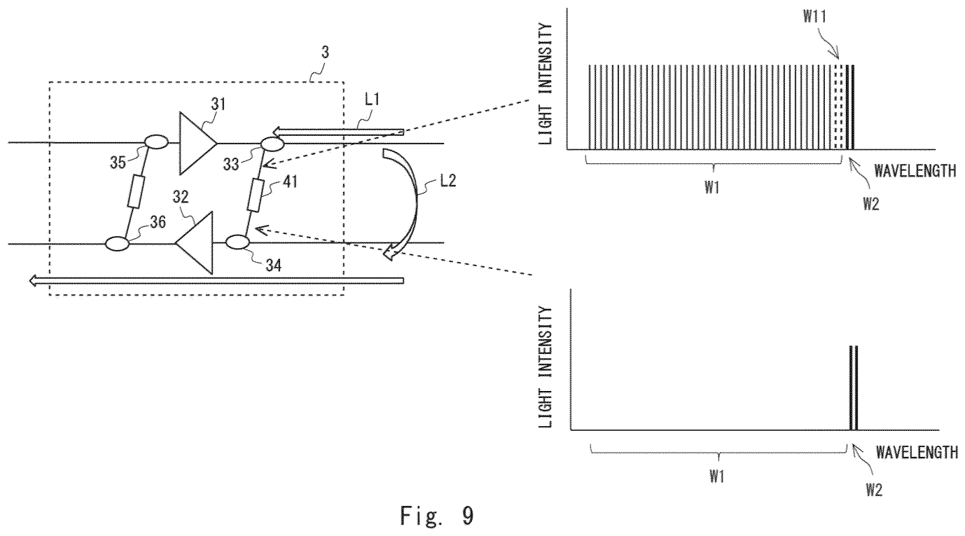

Referring to FIG. 9, an operation of the monitoring system 100 is supplementarily described. The scattered light L1 before passing through the wavelength filter 41 includes a wavelength component having a wavelength W1 cut by the wavelength filter 41 and a wavelength component having a wavelength W2 not cut by the wavelength filter 41. The scattered light L1 that has passed through the wavelength filter 41 includes the wavelength component having the wavelength W2 not cut by the wavelength filter 41. Therefore, when light having a wavelength W11 included in the range of the wavelength W1 is measured, the light intensity of the crosstalk light L2 can be measured by measuring the light intensity of the multiplexed light L3. When the light of the wavelength W2 is measured, the light intensity of the multiplexed light L3 including the scattered light L1 and the crosstalk light L2 can be measured.

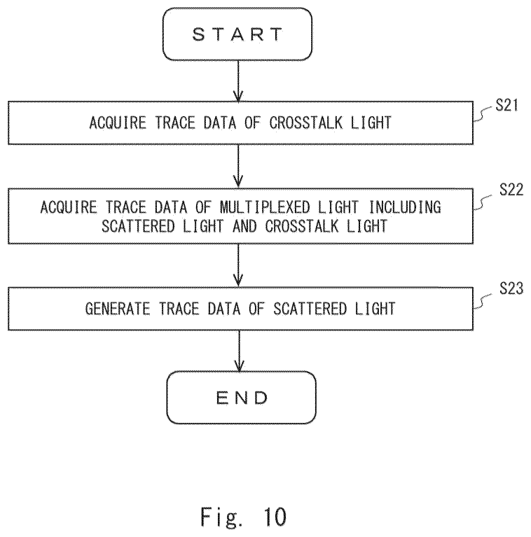

FIG. 10 is a flowchart illustrating an example of the operation of the monitoring system 100. First, the first acquisition unit 111 of the monitoring apparatus 110 measures the light intensity of the wavelength component of the multiplexed light L3 cut by the wavelength filter 41 to thereby acquire the trace data (second trace data) of the crosstalk light L2 (step S21). Next, the second acquisition unit 112 of the monitoring apparatus 110 measures the light intensity of the wavelength component of the multiplexed light L3 not cut by the wavelength filter 41 to thereby acquire the trace data (first trace data) of the multiplexed light L3 including the scattered light L1 and the crosstalk light L2 (step S22). Finally, the calculation unit 113 of the monitoring apparatus 110 subtracts the second trace data from the first trace data, and generates trace data (third trace data) of the scattered light L1 as a difference therebetween (step S23).

The monitoring apparatus 110 may newly measure the second trace data acquired in step S21 each time the first optical transmission line 1 is monitored, or may divert the second trace data measured in the past. As a result, the monitoring apparatus 110 is able to reduce the time required for monitoring.

When monitoring a multi-core transmission line having four or more cores, the monitoring apparatus 110 may divert the second trace data to monitor other core pairs. Note that, in COTDR, since trace data is acquired using two cores, two cores are treated as one pair.

The monitoring apparatus 110 is able to improve the accuracy of checking the normality of the multi-core transmission line by using the wavelength filter 41.

### Third Example Embodiment

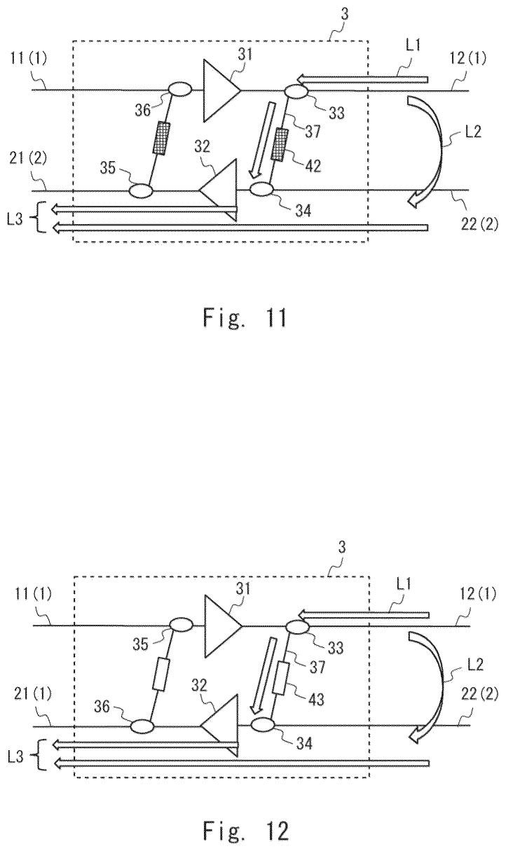

FIG. 11 is a diagram for describing an example of a configuration of a repeater 3 according to the present disclosure. In comparison with the repeater 3 of FIG. 7, a loopback path 37 is provided with a variable optical attenuator 42 instead of the wavelength filter 41. A monitoring system according to the third example embodiment may further include the monitoring apparatus 110 illustrated in FIG. 7.

The repeater 3 may include a control unit (not illustrated). The control unit controls the variable optical attenuator 42 in accordance with a control signal received from the monitoring apparatus 110. This changes the attenuation amount of the loopback path 37. A second acquisition unit 112 of the monitoring apparatus 110 acquires the light intensity of multiplexed light L3 when the attenuation amount of the loopback path 37 is large as the light intensity of crosstalk light L2.

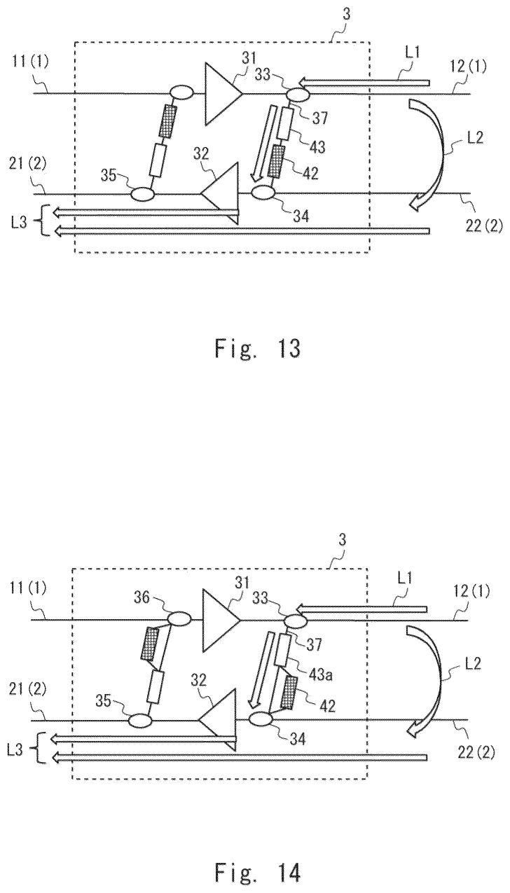

FIG. 12 is a diagram for describing a modified example of the configuration of the repeater 3. Comparing FIG. 11 and FIG. 12, the variable optical attenuator 42 is replaced with an optical switch 43. The control unit of the repeater 3 controls the optical switch 43 in accordance with a control signal received from the monitoring apparatus 110 to thereby change the open/close state of the loopback path 37. The second acquisition unit 112 of the monitoring apparatus 110 may acquire the light intensity of the multiplexed light L3 when the loopback path 37 is in the open state as the light intensity of the crosstalk light L2.

FIG. 13 is a diagram for describing a modified example of the configuration of the repeater 3. Comparing FIG. 12 and FIG. 13, the loopback path 37 of the repeater 3 of FIG. 13 is further provided with a variable optical attenuator 42 connected in series to the optical switch 43. For example, the second acquisition unit 112 of the monitoring apparatus 110 may acquire, as the light intensity of the crosstalk light L2, the light intensity of the multiplexed light L3 when the loopback path 37 is in the open state and the attenuation amount of the variable optical attenuator 42 is large.

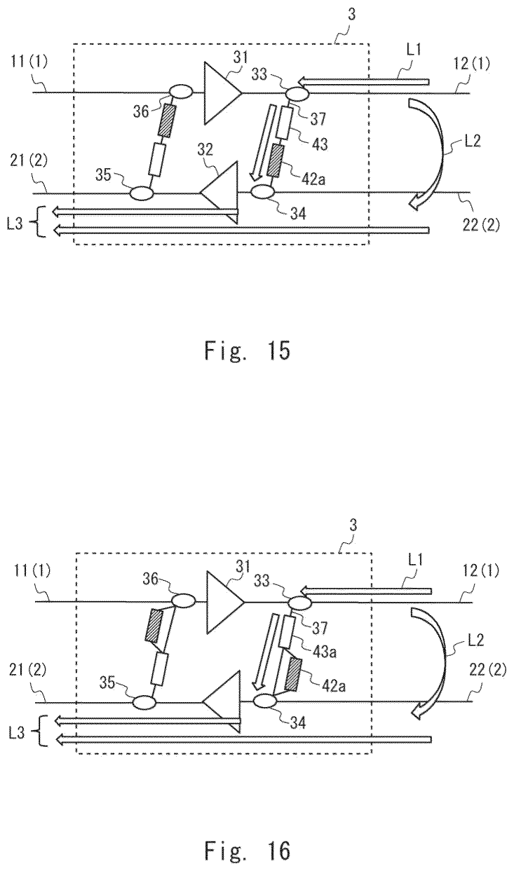

FIG. 14 is a diagram for describing a modified example of the configuration of the repeater 3. Comparing FIG. 13 and FIG. 14, the optical switch 43 is replaced with an optical switch 43a. The optical switch 43a switches a path through which scattered light L1 passes, between a path in which the variable optical attenuator 42 is disposed and a path in which the variable optical attenuator 42 is not disposed. For example, at the time of acquiring the trace data of the crosstalk light L2, the monitoring apparatus may switch the path through which the scattered light L1 passes to the path in which the variable optical attenuator 42 is disposed, and increase the attenuation amount of the variable optical attenuator 42.

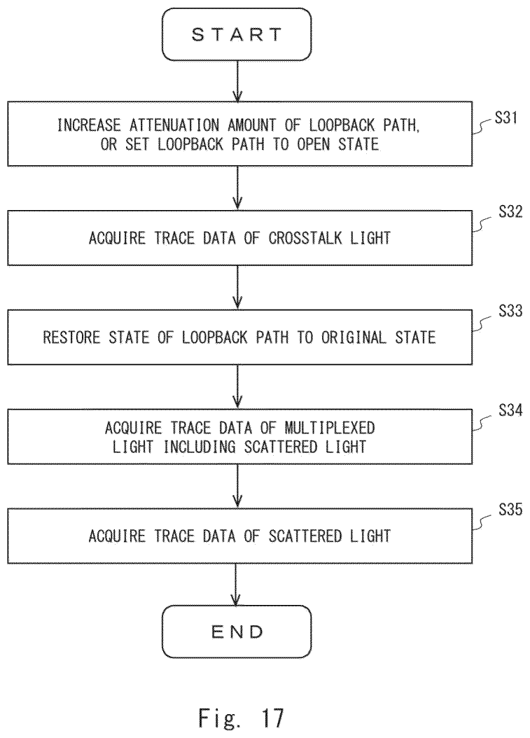

FIG. 15 is a diagram for describing a modified example of the configuration of the repeater 3. Comparing FIG. 13 and FIG. 15, the variable optical attenuator 42 is replaced with a fixed optical attenuator 42a. The scattered light L1 attenuated by the fixed optical attenuator 42a is input to the optical coupler 34. The monitoring system may switch the state of the optical switch 43 to the open state at the time of acquiring the trace data of the crosstalk light L2.

FIG. 16 is a diagram for describing a modified example of the configuration of the repeater 3. Comparing FIG. 14 and FIG. 16, the variable optical attenuator 42 is replaced with a fixed optical attenuator 42a. At the time of acquiring the trace data of the crosstalk light L2, the monitoring apparatus switches the path through which the scattered light L1 passes to a path provided with the fixed optical attenuator 42a. Thereby the attenuation amount of the loopback path 37 that guides the scattered light L1 increases.

FIG. 17 is a flowchart illustrating an example of the operation of the monitoring system according to the present disclosure. First, the monitoring apparatus 110 controls the variable optical attenuator 42, the optical switch 43, or the optical switch 43a of all the repeaters 3 and increases the attenuation amount of the loopback path 37, or sets the loopback path 37 to an open state (step S31). Next, the second acquisition unit 112 of the monitoring apparatus 110 acquires the trace data of the crosstalk light L2 (step S32). Then, the monitoring apparatus 110 controls the variable optical attenuator 42, the optical switch 43, or the optical switch 43a to thereby restore the state of the loopback path 37 changed in step S31 to the original state (step S33). Then, the first acquisition unit 111 of the monitoring apparatus 110 acquires the trace data of the multiplexed light L3 including the scattered light L1 (step S34). Finally, the calculation unit 113 of the monitoring apparatus 110 subtracts the trace data acquired in step S32 from the trace data acquired in step S34, and acquires the trace data of the scattered light L1 as the difference therebetween (step S35). Similarly to the second example embodiment, the trace data acquired in step S32 may be used when monitoring is performed newly or when other core pairs are monitored.

The third example embodiment is able to improve the accuracy of checking the normality of the multi-core transmission line by using an optical switch or a variable optical attenuator.

### Fourth Example Embodiment

The fourth example embodiment is a modified example of the third example embodiment. When trace data of scattered light L1 cannot be generated, a monitoring system according to the fourth example embodiment performs control to reduce the attenuation amount in the loopback path 37, and measures trace data of multiplexed light L3 again.

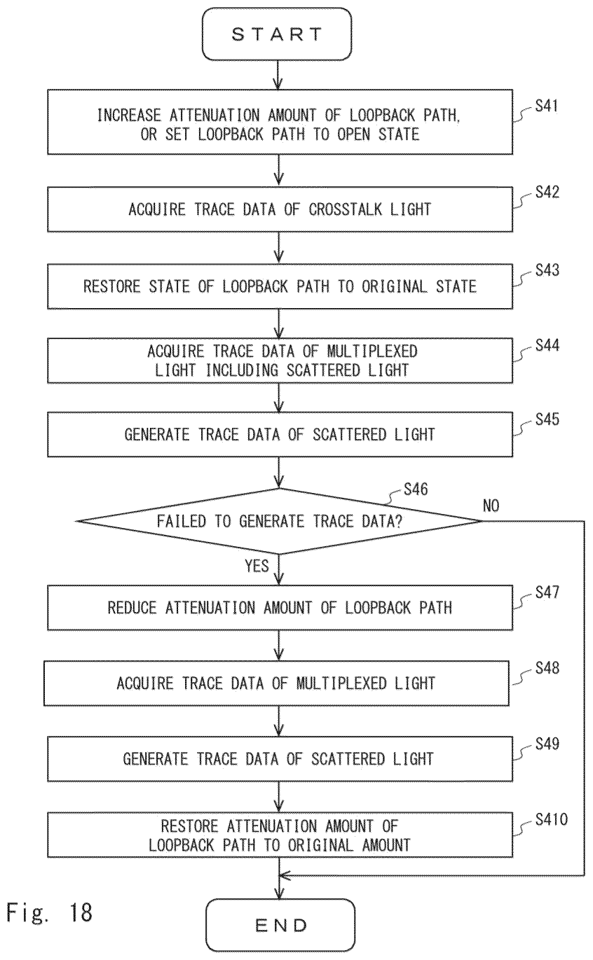

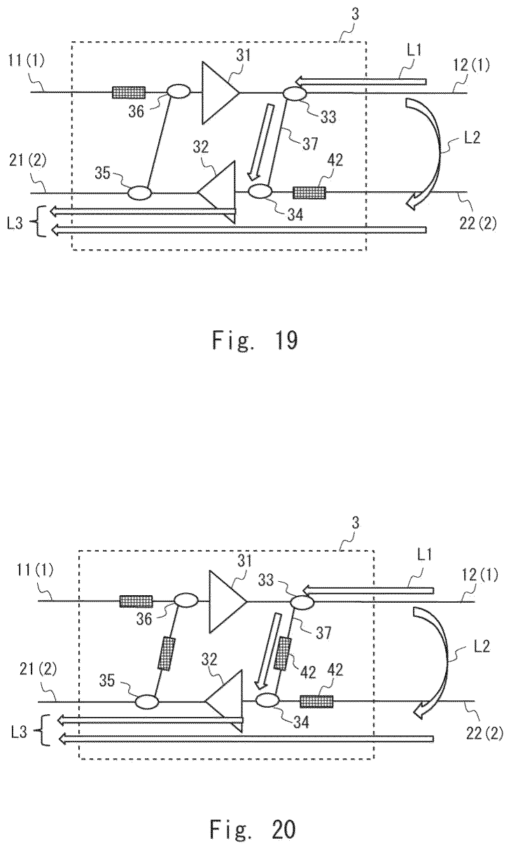

FIG. 18 is a flowchart illustrating an example of an operation of the monitoring system according to the fourth example embodiment. Steps S41 to S45 correspond to steps S31 to S35 in FIG. 17.

When the light intensity of crosstalk light L2 is large, the trace data of the scattered light L1 cannot be generated in step S45. In step S46, a monitoring apparatus 110 determines whether the generation of the trace data of the scattered light L1 has failed. When the trace data of the scattered light L1 is successfully generated (NO in step S46), the monitoring apparatus 110 ends the processing.

When the generation of the trace data of the scattered light L1 fails (YES in step S46), the monitoring apparatus 110 controls a variable optical attenuator 42, an optical switch 43, or an optical switch 43a to thereby reduce the attenuation amount of the loopback path 37 (step S47). For example, the repeater 3 illustrated in FIG. 11 or 13 may set the attenuation amount of the variable optical attenuator 42 to a minimum value.

Next, a first acquisition unit 111 of the monitoring apparatus 110 measures the light intensity of the multiplexed light L3 and acquires the trace data of the multiplexed light L3 (step S48). Next, a calculation unit 113 of the monitoring system subtracts the trace data acquired in step S42 from the trace data acquired in step S48, and generates trace data of the scattered light L1 as the difference therebetween (step S49). Finally, the monitoring system controls the variable optical attenuator 42 or the like to thereby restore the attenuation amount of the loopback path 37 changed in step S47 to the original amount (step S410).

The monitoring system is able to generate trace data of the scattered light L1 even when the light intensity of the crosstalk light L2 is large.

### Fifth Example Embodiment

In the fourth example embodiment, the attenuation amount of the scattered light L1 is being reduced when performing the measurement again. On the other hand, in the fifth example embodiment, an attenuation amount of the light intensity of a crosstalk light L2 is being increased when the measurement is performed again. The fifth example embodiment is a specific example of the first example embodiment.

FIG. 19 is a diagram for describing an example of the configuration of the repeater 3 according to the present disclosure. In comparison with the repeater 3 of FIG. 7, a variable optical attenuator 42 is disposed in a second optical transmission line 2. The variable optical attenuator 42 attenuates the crosstalk light L2 and outputs the attenuated crosstalk light L2 to an optical coupler 34. In a loopback path 37, a wavelength filter 41 may be disposed, or a variable optical attenuator 42 or an optical switch 43 may be disposed.

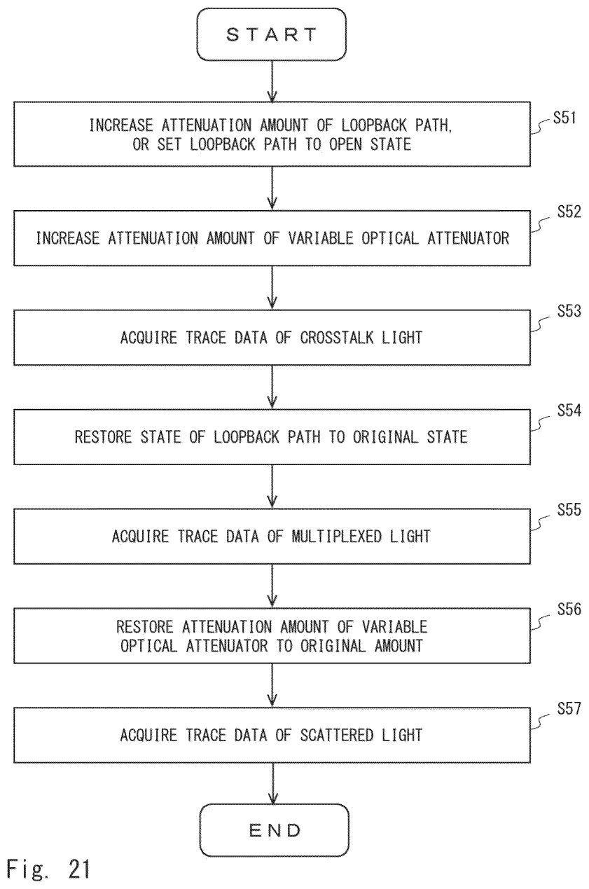

FIG. 20 is a diagram for describing a specific example of the configuration of the repeater 3 according to the present disclosure. As compared with FIG. 19, the variable optical attenuator 42 is disposed in a loopback path 37. The fifth example embodiment may be combined with the third example embodiment, and an optical switch 43, an optical switch 43a, or a fixed optical attenuator 42a may be provided in the loopback path 37.

FIG. 21 is a flowchart illustrating an example of the operation of the monitoring system according to the present disclosure. It is assumed that the generation of the trace data of the scattered light L1 failed. First, a monitoring apparatus 110 controls the variable optical attenuator 42 and increases the attenuation amount in the loopback path 37, or controls the optical switch 43 and sets the loopback path 37 to an open state (step S51). Next, the monitoring apparatus 110 increases the attenuation amount of the variable optical attenuator 42 connected to an optical coupler 34 (step S52). Then, a second acquisition unit 112 of the monitoring apparatus 110 measures the light intensity of the crosstalk light L2 to thereby acquire trace data of the crosstalk light L2 (step S53). Then, the monitoring apparatus 110 performs control to restore the state of the loopback path 37 changed in step S51 to the original state (step S54). The, a first acquisition unit 111 of the monitoring apparatus 110 measures the light intensity of the multiplexed light L3 to thereby acquire the trace data of the multiplexed light L3 (step S55). Then, the monitoring apparatus 110 performs control to restore the attenuation amount of the variable optical attenuator 42 changed in step S52 to the original amount (step S56). Finally, a calculation unit 113 of the monitoring apparatus 110 subtracts the trace data acquired in step S53 from the trace data acquired in step S55, and acquires the trace data of the scattered light L1 as the difference therebetween (step S57).

The fifth example embodiment may also achieve the same effects as the fourth example embodiment.

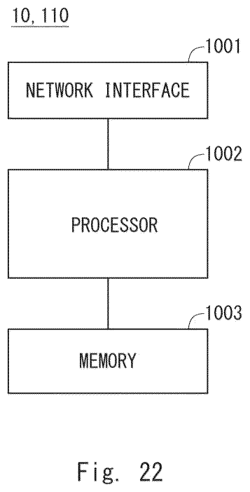

FIG. 22 is a block diagram illustrating an example of a hardware configuration of the monitoring system 10 or the monitoring apparatus 110 (hereinafter, referred to as the monitoring system 10 or the like). Referring to FIG. 22, the monitoring system 10 or the like includes a network interface 1001, a processor 1002, and a memory 1003. The network interface 1001 may be used to communicate with other network node apparatuses constituting the communication system. The network interface 1001 may be used for performing wireless communication. For example, the network interface 1001 may be used for performing wireless-LAN communication defined in IEEE 802.11 series or mobile communication defined in 3rd generation partnership project (3GPP) (registered trademark). Alternatively, the network interface 1001 may include a network interface card (NIC) compliant with IEEE 802.3 series, for example.

The processor 1002 reads and executes software (computer program) from the memory 1003 to thereby perform the processing of steps S11 to S13 in FIG. 6, steps S21 to S23 in FIG. 10, steps S31 to S35 in FIG. 17, steps S41 to S410 in FIG. 18, and steps S51 to S57 in FIG. 21. The processor 1002 may be, for example, a microprocessor, an MPU, or a CPU. The processor 1002 may include a plurality of processors.

The memory 1003 is configured of a combination of a volatile memory and a non-volatile memory. The memory 1003 may include storage located remotely from the processor 1002. In such a case, the processor 1002 may access the memory 1003 via an input/output (I/O) interface (not illustrated).

In the example of FIG. 22, the memory 1003 is being used to store software modules. The processor 1002 can read and execute these software modules from the memory 1003 to thereby perform the processing of steps S11 to S13, S21 to S23, S31 to S35, S41 to S410, and S51 to S57.

As described with reference to FIG. 22, each of the processors included in the monitoring system 10 or the like in the above-described example embodiments executes one or more programs including instructions for causing a computer to perform the algorithm described with reference to the drawings.

In the examples described above, the program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The technical idea according to the present disclosure is not limited to the above-described example embodiments, and can be appropriately modified without departing from the gist thereof.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure. Each of the example embodiments can be combined with other example embodiments as appropriate.

Each of the drawings or figures is merely an example to describe one or more example embodiments. Each figure may be associated with one or more other example embodiments, rather than only one particular example embodiment. As those of ordinary skill in the art will understand, various features or steps described with reference to any one of the figures may be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

The whole or part of the above-described example embodiments may be described as, but not limited to, the following supplementary notes.

Some or all of elements (e.g., configurations and functions) described in supplementary notes 2 to 8 dependent on supplementary note 1 may also be dependent on supplementary notes 9 and 10 in dependency similar to that of supplementary notes 2 to 8 on supplementary note 1. Some or all of elements described in any of the supplementary notes may be applied to various types of hardware, software, recording means for recording software, systems, and methods.

### Supplementary Note 1

A monitoring system including:
a first acquisition unit configured to acquire light intensity of multiplexed light generated by multiplexing scattered light propagating through a first optical transmission line in a multi-core transmission line and crosstalk light propagating through a second optical transmission line by crosstalk between the first optical transmission line and the second optical transmission line;
a second acquisition unit configured to acquire light intensity of the crosstalk light; and
a calculation unit configured to calculate light intensity of the scattered light, based on the light intensity of the multiplexed light and the light intensity of the crosstalk light.

### Supplementary Note 2

The monitoring system according to supplementary note 1, wherein
the first acquisition unit uses an optical time domain reflectometer (OTDR) or coherent optical time domain reflectometry (COTDR) and acquires trace data representing light intensity of the multiplexed light per distance of the first optical transmission line,
the second acquisition unit uses the OTDR or the COTDR and acquires trace data representing light intensity of the crosstalk light per distance of the first optical transmission line, and
the calculation unit generates trace data representing light intensity of the scattered light per distance of the first optical transmission line.

### Supplementary Note 3

The monitoring system according to supplementary note 1 or 2, further including:
a monitoring apparatus including the first acquisition unit, the second acquisition unit, and the calculation unit; and
a repeater including a loopback path configured to guide the scattered light to the second optical transmission line, and an optical coupler configured to multiplex the crosstalk light and scattered light passing through the loopback path.

### Supplementary Note 4

The monitoring system according to supplementary note 3, wherein
a wavelength filter is provided in the loopback path, and
the second acquisition unit acquires light intensity of a wavelength component of the multiplexed light being cut by the wavelength filter as the light intensity of the crosstalk light.

### Supplementary Note 5

The monitoring system according to supplementary note 3, wherein
at least one of an optical switch and a variable optical attenuator is provided in the loopback path,
the repeater includes a control unit configured to control at least one of the optical switch and the variable optical attenuator and thereby change an open/close state or an attenuation amount of the loopback path, and
the second acquisition unit acquires, as the light intensity of the crosstalk light, light intensity of the multiplexed light when the loopback path is in an open state or when an attenuation amount in the loopback path is large.

### Supplementary Note 6

The monitoring system according to supplementary note 3, wherein
at least one of an optical switch and a variable optical attenuator is provided in the loopback path,
the repeater includes a control unit configured to control at least one of the optical switch and the variable optical attenuator and thereby change an attenuation amount of the loopback path, and,
when the light intensity of the scattered light cannot be calculated, the monitoring apparatus reduces the attenuation amount of the loopback path, acquires the light intensity of the multiplexed light again, and calculates the light intensity of the scattered light again.

### Supplementary Note 7

The monitoring system according to supplementary note 3, wherein
the repeater includes a variable optical attenuator configured to attenuate the crosstalk light being input to the optical coupler, and a control unit configured to control the variable optical attenuator, and,
when the light intensity of the scattered light cannot be calculated, the monitoring apparatus increases an attenuation amount of the variable optical attenuator, acquires the light intensity of the multiplexed light and the light intensity of the crosstalk light again, and calculates the light intensity of the scattered light again.

### Supplementary Note 8

The monitoring system according to supplementary note 3, wherein the repeater includes an amplifier configured to amplify the multiplexed light.

### Supplementary Note 9

A monitoring method including:
acquiring light intensity of multiplexed light generated by multiplexing scattered light propagating through a first optical transmission line in a multi-core transmission line and crosstalk light propagating through a second optical transmission line by crosstalk between the first optical transmission line and the second optical transmission line;
acquiring light intensity of the crosstalk light; and
calculating light intensity of the scattered light, based on the light intensity of the multiplexed light and the light intensity of the crosstalk light.

### Supplementary Note 10

A program causing a computer to execute:
processing of acquiring light intensity of multiplexed light generated by multiplexing scattered light propagating through a first optical transmission line in a multi-core transmission line and crosstalk light propagating through a second optical transmission line by crosstalk between the first optical transmission line and the second optical transmission line;
processing of acquiring light intensity of the crosstalk light; and
processing of calculating light intensity of the scattered light, based on the light intensity of the multiplexed light and the light intensity of the crosstalk light.

What is claimed is:

1. A monitoring system comprising:
at least one memory storing instructions and
at least one processor configured to execute the instructions to;
acquire light intensity of multiplexed light generated by multiplexing scattered light propagating through a first optical transmission line in a multi-core transmission line and crosstalk light propagating through a second optical transmission line by crosstalk between the first optical transmission line and the second optical transmission line;
acquire light intensity of the crosstalk light; and
calculate light intensity of the scattered light, based on the light intensity of the multiplexed light and the light intensity of the crosstalk light.

2. The monitoring system according to claim 1, wherein the at least one processor is configured to execute the instructions to:
use an optical time domain reflectometer (OTDR) or coherent optical time domain reflectometry (COTDR) and acquire trace data representing light intensity of the multiplexed light per distance of the first optical transmission line,
use the OTDR or the COTDR and acquire trace data representing light intensity of the crosstalk light per distance of the first optical transmission line, and
generate trace data representing light intensity of the scattered light per distance of the first optical transmission line.

3. The monitoring system according to claim 1, comprising:
a monitoring apparatus including the at least one memory and the at least one processor; and
a repeater including a loopback path configured to guide the scattered light to the second optical transmission line, and an optical coupler configured to multiplex the crosstalk light and scattered light passing through the loopback path.

4. The monitoring system according to claim 3, wherein
a wavelength filter is provided in the loopback path, and
the at least one processor acquires light intensity of a wavelength component of the multiplexed light being cut by the wavelength filter as the light intensity of the crosstalk light.

5. The monitoring system according to claim 3, wherein
at least one of an optical switch and a variable optical attenuator is provided in the loopback path,
the repeater includes a control unit configured to control at least one of the optical switch and the variable optical attenuator and thereby change an open/close state or an attenuation amount of the loopback path, and
the at least one processor acquires, as the light intensity of the crosstalk light, light intensity of the multiplexed light when the loopback path is in an open state or when an attenuation amount in the loopback path is large.

6. The monitoring system according to claim 3, wherein
at least one of an optical switch and a variable optical attenuator is provided in the loopback path,
the repeater includes a control unit configured to control at least one of the optical switch and the variable optical attenuator and thereby change an attenuation amount of the loopback path, and,
when the light intensity of the scattered light cannot be calculated, the monitoring apparatus reduces the attenuation amount of the loopback path, acquires the light intensity of the multiplexed light again, and calculates the light intensity of the scattered light again.

7. The monitoring system according to claim 3, wherein
the repeater includes a variable optical attenuator configured to attenuate the crosstalk light being input to the optical coupler, and a control unit configured to control the variable optical attenuator, and,
when the light intensity of the scattered light cannot be calculated, the monitoring apparatus increases an attenuation amount of the variable optical attenuator, acquires the light intensity of the multiplexed light and the light intensity of the crosstalk light again, and calculates the light intensity of the scattered light again.

8. The monitoring system according to claim 3, wherein the repeater includes an amplifier configured to amplify the multiplexed light.

9. A monitoring method comprising:
acquiring light intensity of multiplexed light generated by multiplexing scattered light propagating through a first optical transmission line in a multi-core transmission line and crosstalk light propagating through a second optical transmission line by crosstalk between the first optical transmission line and the second optical transmission line;
acquiring light intensity of the crosstalk light; and
calculating light intensity of the scattered light, based on the light intensity of the multiplexed light and the light intensity of the crosstalk light.

10. A non-transitory computer readable medium storing a program causing a computer to execute:
processing of acquiring light intensity of multiplexed light generated by multiplexing scattered light propagating through a first optical transmission line in a multi-core transmission line and crosstalk light propagating through a second optical transmission line by crosstalk between the first optical transmission line and the second optical transmission line;
processing of acquiring light intensity of the crosstalk light; and
processing of calculating light intensity of the scattered light, based on the light intensity of the multiplexed light and the light intensity of the crosstalk light.
